(19) United States
(12) Patent Application Publication
(10) Pub. No.: US 2016/0241671 A1
(43) Pub. Date: Aug. 18, 2016

(54) PROFILE UPDATE EVALUATOR

(71) Applicant: Linkedln Corporation, Mountain View, CA (US)

(72) Inventors: Arpit Amar Goel, Palo Alto, CA (US); Saveliy Uryasev, Sunnyvale, CA (US); Craig Martell, San Juan Bautista, CA (US); Uri Merhav, Rehovot (IL)

(21) Appl. No.: 14/621,166

(22) Filed: Feb. 12, 2015

(51) Int. Cl. H04L 29/08

(52) U.S. Cl. CPC H04L 67/306; H04L 67/02

(57) ABSTRACT

A profile update evaluator is configured to detect a change to profile data in a member profile and determine whether the change can be viewed as indicative of a positive professional transition for a member represented by the profile. If the change can be viewed as indicative of a positive professional transition, the profile update evaluator publishes the update to the member's network. Absent an indication that the change can be viewed as indicative of a positive professional transition, the profile update evaluator does not publish the update to the member's network and does not invite the member's connections to congratulate her on the job change.

### TECHNICAL FIELD

This application relates to the technical fields of software and/or hardware technology and, in one example embodiment, to system and method to evaluate an update to a profile representing a member in an on-line social network system.

### BACKGROUND

An on-line social network may be viewed as a platform to connect people in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and education of the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to evaluate an update to a profile representing a member in an on-line social network system may be implemented;

FIG. 2 is block diagram of a system to evaluate an update to a profile representing a member in an on-line social network system, in accordance with one example embodiment;

FIG. 3 is a flow chart illustrating a method to evaluate an update to a profile representing a member in an on-line social network system, in accordance with an example embodiment;

FIG. 4 is a flow chart illustrating a method to determine whether an update to a profile representing a member in an on-line social network system indicates a positive professional transition, in accordance with an example embodiment; and

FIG. 5 is a diagrammatic representation of an example machine in the form of a computer system within which a set of instructions, for causing the machine to perform any one or more of the methodologies discussed herein, may be executed.

### DETAILED DESCRIPTION

A method and system to evaluate an update to a profile representing a member in an on-line social network system is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrases “an on-line social networking application” and “an on-line social network system” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). A member profile may be associated with social links that indicate the member's connection to other members of the social network. A member profile may also include or be associated with comments or recommendations from other members of the on-line social network, with links to other network resources, such as, e.g., publications, etc. As mentioned above, an on-line social networking system may be designed to allow registered members to establish and document networks of people they know and trust professionally. Any two members of a social network may indicate their mutual willingness to be “connected” in the context of the social network, in that they can view each other's profiles, profile recommendations and endorsements for each other and otherwise be in touch via the social network. Members that are connected in this way to a particular member may be referred to as that particular member's connections or as that particular member's network.

The profile information of a social network member may include personal information such as, e.g., the name of the member, current and previous geographic location of the member, current and previous employment information of the member, information related to education of the member, information about professional accomplishments of the member, publications, patents, etc. The profile information of a social network member may also include information about the member's professional skills. Information about a member's professional skills may be referred to as professional attributes. Professional attributes may be maintained in the on-line social network system and may be used in the member profiles to describe and/or highlight professional background of a member. Some examples of professional attributes (also referred to as merely attributes, for the purposes of this description) are strings representing professional skills that may be possessed by a member (e.g., “product management,” “patent prosecution,” “image processing,” etc.). Thus, a member profile may indicate that the member represented by the profile is holding himself out as possessing certain skills.

Information about a member's professional experience, e.g., information about current and past employment, includes data such as company names and the corresponding professional titles. Members of an on-line social network are permitted to update information related to their current and past employment. These updates may reflect various events, such as, e.g., a member transitioning to another company, a member being promoted or demoted within the same company, a change in the meaning of the professional title, a change to unemployment or volunteer status, etc. An update may be performed by a member by adding a new entry in the employment history section of their profile or by merely editing an existing entry. An entry in the employment history section of a member profile may be referred to as a job position entry. A job position entry includes a field for a string that represents a company name and a field for a string that represents a professional title of a member at that company.

In order to increase engagement among users, an on-line social network system may be configured to publish all or just some of the updates to a user profile. When an update is with respect to a job transition of a particular member, other members of the on-line social network, e.g., connections of the particular member, may be presented with the job transition information of the particular member. In some embodiments, connections of the particular member are also presented with an invitation to congratulate the particular member on the job change. The publishing of a job transition update to the member's network via a user interface may not, however, be appropriate or welcome where the change in a member's job position is not a positive professional transition, e.g., where the new job position indicates unemployment or a demotion.

An automated process to determine whether the change to profile data is indicative of a positive professional transition and therefore warrants an announcement to the member's network may be referred to as a method to evaluate an update to a profile representing a member in an on-line social network system. At a very high level tools and models used by a system to evaluate an update to a member profile are from the field of large scale data mining, natural language processing, and machine learning, using LinkedIn network data.

A system to evaluate an update to a member profile—a profile update evaluator—may be configured to detect a change to profile data in a member profile and determine whether the change can be viewed as indicative of a positive professional transition for a member represented by the profile. If the change can be viewed as indicative of a positive professional transition, the profile update evaluator publishes the update to the member's network and, in some embodiments, presents on the connections' respective news feed pages a visual control selectable to trigger a congratulatory communication to be sent to the member. Absent an indication that the change can be viewed as indicative of a positive professional transition, the profile update evaluator does not publish the update to the member's network and does not invite the member's connections to congratulate him with a job change. For example, an update related to a job change of a member may be published on the news feed page of the member's connection. In addition to publishing an update related to a job change of a member, the profile update evaluator, in some embodiments, causes an invitation to congratulate the member to be presented on a display device of one or more other members of the on-line network system. As mentioned above, members of an on-line social network may be connected by means of social links recorded in their respective profiles.

In order to determine whether the change can be viewed as indicative of a positive professional transition for a member represented by the profile, a profile update evaluator may examine one or more strings in the profile that represent the new current position (the current job position as it appears after the profile update) as compared to the respective one or more strings in the profile that represent the old current position (the current job position as it appeared prior to the profile update). The strings that are being examined may be referred to as a new company name string, a previous company name string, a new title string, and a previous title string. The new company name string and the new title string represent the current job position after the profile update, while the previous company name string and the previous title string represent the current job position of the member as it appeared prior to the profile update. In one embodiment, a profile update evaluator identifies a change to profile data as indicative of a positive professional transition when the new company name string and the previous company name string have been determined to represent different companies (in other words, the change to the current company name suggests that the member transitioned from one company to another). Another scenario where a profile update evaluator identifies a change to profile data as indicative of a positive professional transition is when the pair comprising a new title string and a previous title string indicates a professional promotion of the associated member.

As mentioned above, a new company name string and a new title string may be a result of a member creating a new job position entry in their member profile. In this scenario, a profile update evaluator accesses the new company name string and the new title string provided in a newly-created entry and also accesses respective previous company name string and previous title string provided in an earlier-created job position entry. Sometimes, members, rather than adding a new job position entry to their profile, instead just edit the existing latest job title entry, even when the change reflected in the update indicates a promotion or a company switch. In this scenario, a profile update evaluator does not discard the previous company name string and the previous title string as they appeared in the latest job title entry before the update, at least until these strings are examined with respect to the new company name string and the new title string as they appear in the latest job position entry after the update.

A profile update evaluator may also be configured to determine whether the profile update indicates that the member is no longer employed and, if so, cause the profile update to not be published to the member's network. In one embodiment, this determination may be made based on examining the one or more strings in the profile that represent the new current position with respect to a dictionary of terms that have been identified as indicative of lack of employment or lack of paid employment. For example, such dictionary of terms may include phrases such as “unemployed,” “looking for a job,” “volunteer,” etc. If the new company name string or the new title string includes a phrase indicative of lack of employment, the profile update is not published to the member's network. It will be noted, that the member's connections may be still permitted to view such update to the member's profile data by visiting the profile page of the member.

As stated above, in some embodiments, a member's transition to a different company is viewed by the profile update evaluator as indicative of a positive professional transition, which would trigger the publication of the update to the member's network.

The profile update evaluator can be configured to examine the new company name string and the previous company name string using a company similarity model to determine whether the update to profile data indicates a company switch. In some embodiments, this determination is commenced after the profile update evaluator establishes that the change to profile data does not indicate that the associated member is no longer employed. The process of determining whether the update to profile data indicates a company switch may be referred to as a company similarity phase. The company similarity phase, in one example embodiment is based on a modification of term frequency-inverse document frequency (tf-IDF) score. The profile update evaluator accesses a list of previously collected/observed company names and creates a list of phrases that occur in company names from the list. For each such phrase, the profile update evaluator generates an inverse document weighted score. This inverse document score is then scaled using Platt scaling to get a number between 0 and 1. A number closer to 0 indicates that the phrase is very frequent in the company names that are included in the list and therefore is less likely to be part of a distinctive company name. A number closer to 1 indicates that the phrase is less frequent in the company names that are included in the list and therefore is more likely to be part of a distinctive company name.

Then the profile update evaluator calculates word by word similarity for previous company name string and new company name string. Specifically, for each word in previous company name string the nearest (in terms of edit distance) word in new company name string is located. The edit distance score is inverse-weighed by the idf-scaled-score for the given word. Thus calculates inverse-weighed edit distance scores are summed over all words in previous company name string to calculate the final tf-IDF score for the previous company name string with respect to the new company name string. Similarly, for each word in the new company name string the nearest (in terms of edit distance) word in previous company name string is located. The edit distance score is inverse-weighed by the idf-scaled-score for the given word. Thus calculates inverse-weighed edit distance scores are summed over all words in new company name string to calculate the final tf-IDF score for the new company name string with respect to the previous company name string. These final tf-IDF scores calculated for the previous company name string with respect to the new company name string and or the new company name string with respect to the previous company name string may be referred to as a company change scores. If any of these two scores are sufficiently high, e.g., as compared to a predetermined threshold, the new company name string and the previous company name string are identified by the profile update evaluator as representing different companies. If neither of these two scores are sufficiently high as compared to a predetermined threshold, the new company name string and the previous company name string are identified by the profile update evaluator as representing the same company. Thus, in one embodiment, based on the company change scores, the profile update evaluator may selectively publish an announcement of the update to a member's profile to the member's network.

As explained above, a positive professional transition may also be indicated by a change in the current job title that suggests a job promotion. For example if a member changed her job title from “Graduate Student” to “Graduate Researcher,” the profile update evaluator recognizes that this change to the job position is a positive professional transition, in that the “Graduate Researcher” title is associated with increased seniority as compared to the “Graduate Student” title. The profile update evaluator may then trigger a process for publishing this update to the member's network. The update is published regardless of whether the new title was added via a new job position entry or by editing an existing entry.

Comparing titles may start with determining respective canonical or standardized titles that correspond to the new and old title strings. In processing of a title string to identify a corresponding canonical job title, a profile update evaluator may utilize a so-called n-gram language model, which may be constructed to evaluate respective frequencies of occurrence and co-occurrence, as well as conditional probabilities for n-grams that appear in a subject title. Canonicalization of a given subject title may involve extracting n-grams from the subject title and, for every extracted n-gram, calculating frequency of occurrence value and one or more conditional probabilities with respect to a corpus of title strings selected from title strings stored in the on-line social network system. An n-gram will be understood as a set of n items from a given sequence of text.

An n-gram language model may be utilized to learn that a phrase, such as “VP of Engineering” is often a complete phrase, whereas “VP of” is almost never a complete phrase. In other words, an n-gram language model may provide an objective way to ascertain what might be a reasonable job title, where a reasonable job title is a title string that often appears in the dataset of title strings as a complete phrase and rarely appears as an incomplete phrase and is also ubiquitous to some extent. In one embodiment, an n-gram language model may be configured to reject those n-grams that do not appear often enough in the dataset of title strings. With reference to the Example (1) above, some of the n-grams extracted from the core title identified for the subject profile (“vp of hr yahoo.com”) include strings “vp of,” “hr yahoo.com,” and “vp of hr.”

In one embodiment, the frequency of occurrence value for an n-gram reflects the frequency, with which the n-gram appears in the learning corpus of job titles that are stored in member profiles associated with the same industry as an industry associated with the subject profile. An n-gram language model may calculate conditional probability of the subject n-gram being followed by the <end> token. The <end> token may be used to indicate the end of the subject core title. For instance, this conditional probability value may indicate what percentage of the time, of all the times the term “vp of” appears in the corpus, it is followed by some other word, as opposed to being followed by the <end> token. Another conditional probability value may indicate probability of the n-gram being preceded by the <start> token (that indicates the beginning of the subject core title) and also being followed by the <end> token. Based on the calculated respective frequencies of occurrence and the conditional probabilities, the model may select an n-gram that is deemed to provide the best description of the member's job and identify the selected n-gram as a canonical title that corresponds to the raw title string.

In one example embodiment, each n-gram extracted from a title string may be assigned scores corresponding to results of comparisons of calculated respective frequencies of occurrence and the conditional probabilities with respective thresholds, and the model may select the highest-scoring n-gram as the canonical title. Provided two or more n-grams have the same score, the longest n-gram may be selected as the canonical title. Alternatively, the selection of an n-gram may be based on one of the scores, while the other scores may be used to exclude an n-gram from the consideration for the canonical title. With reference to the Example (1) above, the string “vp of hr” would be selected as the canonical title that corresponds to the title string. The canonical title determined as the result of applying an n-gram language model to the raw title string may be then associated with the subject member profile, and the association may be stored in a database for future use.

The profile update evaluator applies the above-described methodology to derive respective standardized titles for the new title string and the previous title string then examines these standardized title strings to determine whether the transition represented by the new title string and the previous title string suggests a professional advancement or a promotion.

In one embodiment, the profile update evaluator determines whether the transition represented by the new title string and the previous title string suggests a professional advancement or a promotion by identifying one or more seniority modifiers that are present in the new title string and lacking from the previous title string or vice versa. Example seniority modifiers are phrases like “senior,” “assistant,” “intern,” etc. that have been determined to provide information regarding professional seniority. Seniority modifiers in a title strings may be identified by consulting a dictionary of seniority modifiers. In a dictionary of seniority modifiers each seniority modifier may be associated with a flag or a value that indicates whether the modifier increases or decreases seniority when it is added to a title string. For example, the seniority modifiers “assistant” and “intern” are flagged in a dictionary as indicative of a lesser seniority, while the seniority modifiers “senior” and “principal” are flagged in a dictionary as indicative of a greater professional seniority According to one embodiment, a dictionary of modifier phrases, including seniority modifiers, may be generated using an example approach described below.

According to one example embodiment, in order to identify seniority modifiers in the title strings provided in member profiles in an on-line social network system, a profile update evaluator may leverage so-called transition data. Transition data, in the context of this specification, is information that may be gleaned from a member profile with respect to the member's transition from one professional position to another. Transition data, for the purposes of this description, may be in the form of pairs of title strings, transition items, where a transition item includes two title strings (e.g., “software developer” and “senior software developer”). One title string in a transition item is typically associated with a first time period, while the other title string is associated with a second time period.

In operation, a profile update evaluator examines transitions between jobs that the members of the on-line social network system have reported via their respective profiles. For example, a member profile may include information indicating that the member represented by the profile transitioned from a position represented by the title “data scientist” to a position represented by the title “senior data scientist” or from a position having the title “manager” to a position represented by the title “regional manager.”

For every transition item extracted from a sample set of member profiles, a profile update evaluator determines whether it conforms to a stable pattern across the sample set of member profiles with respect to a potential modifier phrase. Such pattern may indicate that a position represented by title string “X” is typically followed by a position represented by title string “Y X” (e.g., the results of examination of transition data extracted from the sample set of data profiles indicates that a position represented by the title “data scientist” is typically followed by a position represented by the title “senior data scientist”). Another pattern may indicate that a position represented by title string “YX” is typically followed by a position represented by title string “X” (e.g., the results of examination of transition data extracted from the sample set of data profiles indicates that a position represented by the title “assistant manager” is typically followed by a position represented by the title “manager”). Yet another pattern may indicate that a position represented by title string “XY” is typically followed by a position represented by title string “X” (e.g., the results of examination of transition data extracted from the sample set of data profiles indicates that a position represented by the title “data scientist intern” is typically followed by a position represented by the title “data scientist”). Yet another pattern may indicate that a position represented by title string “XY” is typically followed by a position represented by title string “X” (e.g., the results of examination of transition data extracted from the sample set of data profiles indicates that a position represented by the title “data scientist intern” is typically followed by a position represented by the title “data scientist”).

In one embodiment, in order to determine whether a transition item conforms to a stable pattern across the sample set of member profiles, a profile update evaluator may utilize a model that may be constructed and applied to the member profiles. One of the rules employed by the model may be to infer that a certain transition pattern is a stable pattern if more than or equal to a certain percentage (e.g., 80%) of all transition items that are being examined that include a first title string and a second title string are characterized by a certain pattern: e.g., a potential modifier phrase is present in the first title string and is lacking from the second title string or vice versa. If a transition item comprising a first title string and a second title string was determined to be conforming to a stable pattern, a phrase that is included in the first title string and is lacking from the second title string is identified as a modifier phrase and stored in a dictionary for future use.

A modifier phrase, also referred to as merely a modifier, may include one or more words. A profile update evaluator may determine that a modifier relates to seniority if more than or equal to a certain percentage of all transition items that are being examined that include the modifier are characterized by a pattern, where a position represented by the first title string that includes the modifier is associated with a time period that is less recent than the position represented by the second title string that lacks the modifier, or vice versa. In other words, a profile update evaluator may determine that, for example, the word “senior” is typically added to a job title that represents a more recent position (people move up in ranks), but is almost never removed from a job title that represents an earlier position. Thus it may be inferred that the word “senior” is indicative of seniority. Similarly, the word “intern” is typically removed from a job title that represents a less recent position, but is almost never added to a job title that represents later position. Some words, like “general,” may be determined to be indicative of seniority consistently in some industries but not so in others. For example the job title “general manager” may signify a more senior position than the job title “manager,” while the job title “general nurse” may not indicate increased seniority as compared to the job title “nurse.”

In one embodiment, in order to determine seniority weights for canonical titles and modifier phrases, a seniority profile update evaluator employs a seniority standardization model (also termed merely a model for the purposes of this description) constructed to examine transition data from the member profiles maintained by the on-line social network and to determine how various canonical titles and modifier phrases that may appear in the title strings affect professional seniority of a member represented by a profile that identifies the member as having a particular title. For example, the model may identify the modifier phrase “senior” as having a significant positive effect on the seniority associated with the title string because in the majority of transition items where the word “senior” appears in one of the title strings, that title string is associated with a more recent position. Or, the model may identify the modifier phrase “associate” as having a negative effect on the seniority associated with the title string because in the majority of transition items, where the word “senior” appears in one of the title strings, that title string is associated with a less recent position.

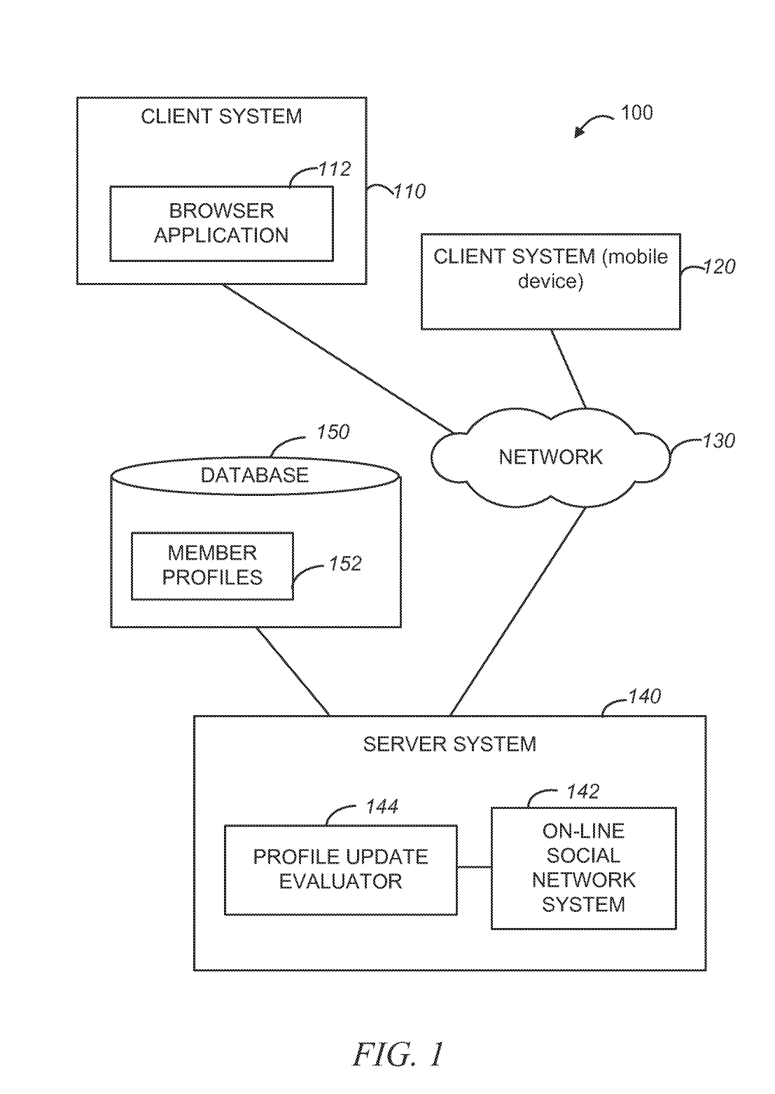

In one embodiment, a profile update evaluator determines that the transition represented by the new title string and the previous title string suggests a professional advancement or a promotion if a seniority modifier indicative of greater seniority has been detected in the new title string and not in the previous title string or if a seniority modifier indicative of lesser seniority has been detected in the previous title string and not in the new title string. In one embodiment, a profile update evaluator determines that the transition represented by the new title string and the previous title string suggests a professional advancement or a promotion if the previous title string and the new title string are sufficiently different or dissimilar. Similarity of the previous title string and the new title string may be determined using a variety of approaches, including the combination of edit distance scoring and a term frequency inverse document frequency approach described above with respect to determining whether a current company represented by the new company name string is distinct from a previous company represented by the previous company name string. An example profile update evaluator may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152.

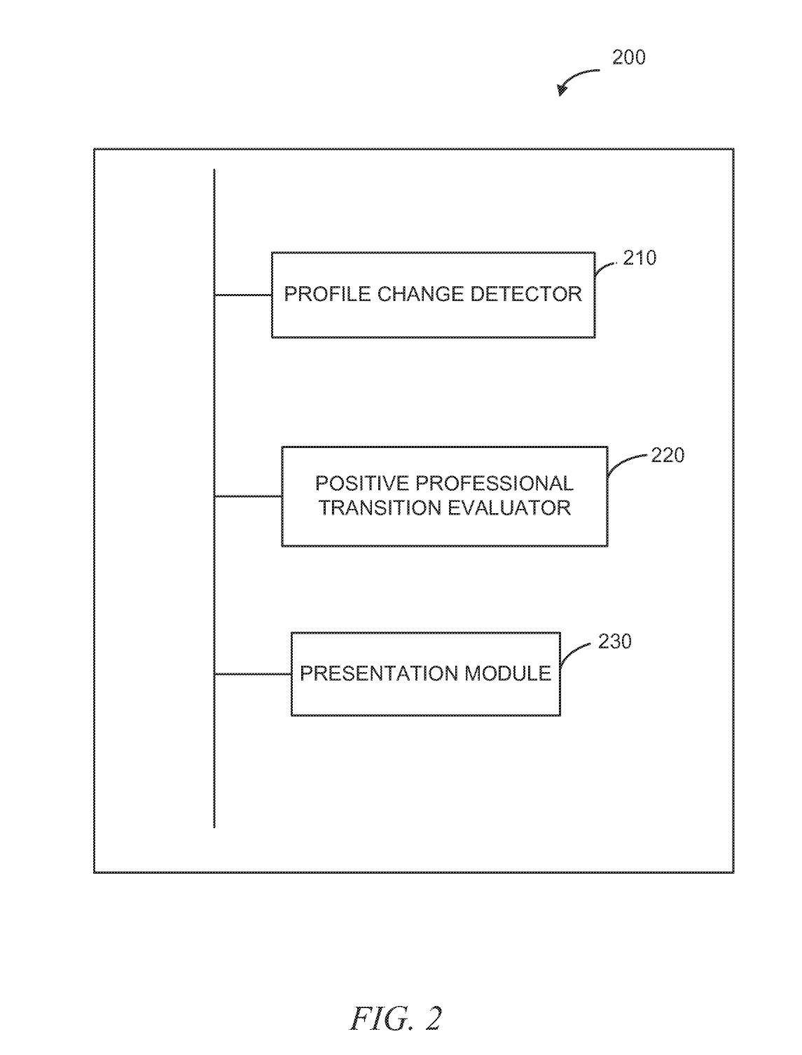

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a profile update evaluator 144. The profile update evaluator 144 may be configured to detect a change to profile data in a member profile from the member profiles 152 stored in the database 150 and determine whether the change can be viewed as indicative of a positive professional transition for a member represented by the profile. As explained above, if the change can be viewed as indicative of a positive professional transition, the profile update evaluator 144 publishes the update to the member's network and, in some embodiments, presents on the connections' respective news feed pages a visual control selectable to trigger a congratulatory communication to be sent to the member. Absent an indication that the change can be viewed as indicative of a positive professional transition, the profile update evaluator 144 does not publish the update to the member's network and does not invite the member's connections to congratulate him with a job change. An example profile update evaluator 144 is illustrated in FIG. 2.

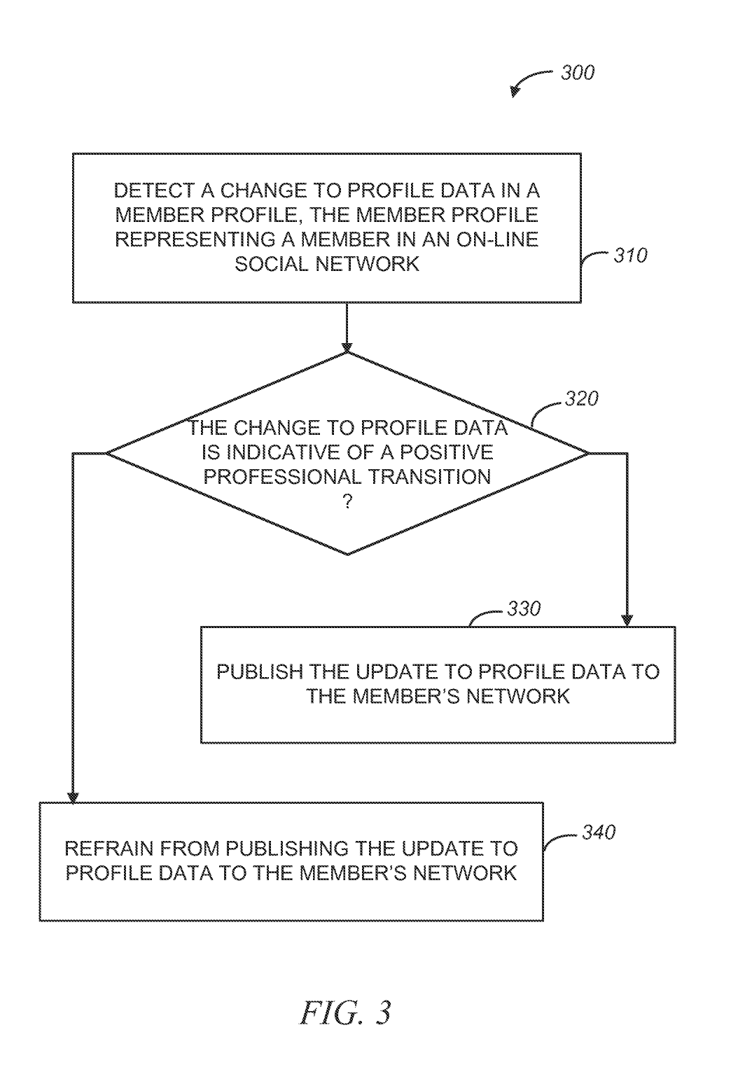

FIG. 2 is a block diagram of a system 200 to evaluate an update to a profile representing a member in an on-line social network system 142 of FIG. 1. As shown in FIG. 2, the system 200 includes a profile change detector 210, a positive professional transition evaluator 220, and a presentation module 230. The profile change detector 210 is configured to detect a change to profile data in a member profile, the member profile representing a member in an on-line social network. The positive professional transition evaluator 220 is configured to determine that the change to profile data is indicative of a positive professional transition. The presentation module 230 is configured to cause an announcement related to the change to the profile data to be presented on a display device. Some operations performed by the system 200 may be described with reference to FIG. 3.

FIG. 3 is a flow chart of a method 300 to evaluate an update to a profile representing a member in an on-line social network system 142 of FIG. 1. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the profile change detector 210 of FIG. 2 detects a change to profile data in a member profile representing a member in an on-line social network. At operation 320, the positive professional transition evaluator 220 of FIG. 2 determines whether the change to profile data is indicative of a positive professional transition. If so, the presentation module 230 of FIG. 2 publishes the change/update to the profile data to the network of the member represented by the profile at operation 330. Otherwise, if the positive professional transition evaluator 220 of FIG. 2 determines, at operation 330, that the change to profile data is not indicative of a positive professional transition, the presentation module 230 refrains from publishing the change/update to the profile data to the network of the member represented by the profile, at operation 340. The publishing of the change/update to the profile data to the network of the member includes causing an announcement related to the change to the profile data to be presented on a display device. As explained above, the causing of the announcement related to the change to the profile data to be presented on a display device may include causing a presentation of a visual control selectable to trigger a communication, such as a congratulation, to be sent to the member.

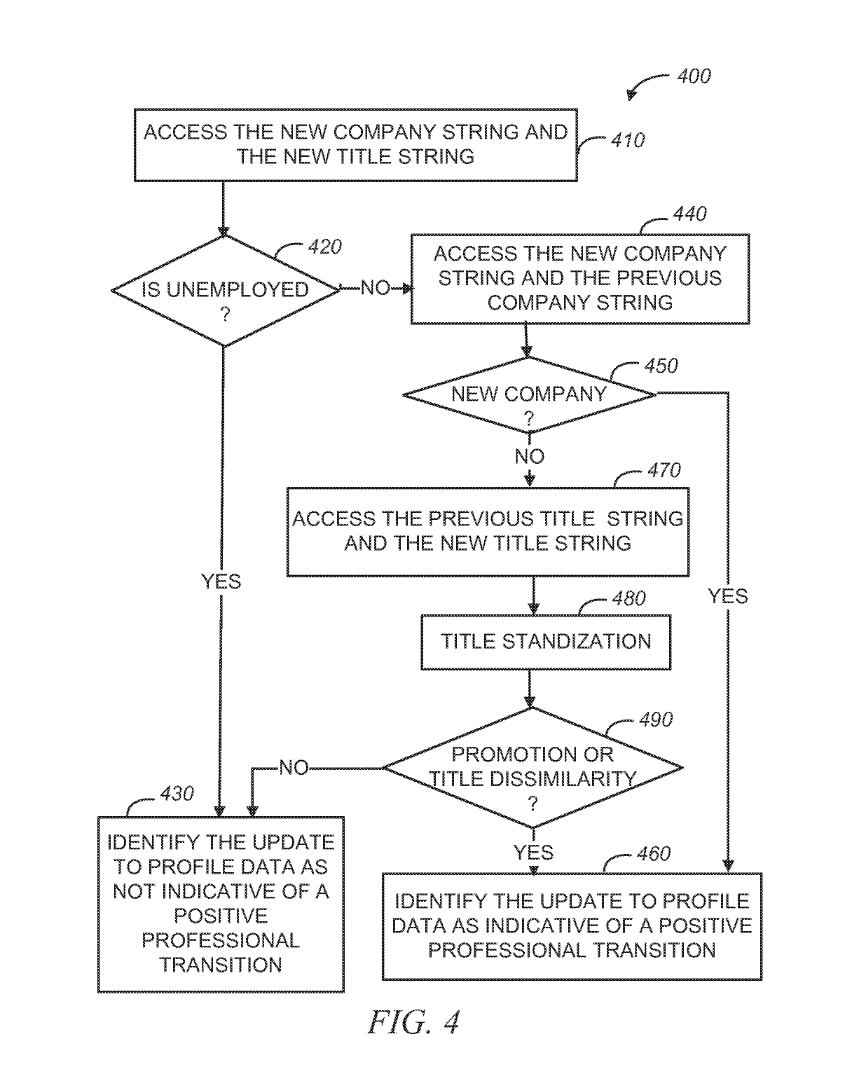

FIG. 4 is a flow chart of a method 400 to determine whether an update to a profile representing a member in an on-line social network system indicates a positive professional transition. The method 400 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As explained above, in order to determine whether the change can be viewed as indicative of a positive professional transition for a member represented by the profile, a profile update evaluator may examine one or more strings in the profile that represent the change to the member's job position, specifically, a new company name string, a previous company name string, a new title string, and a previous title string. As shown in FIG. 4, the method 400 commences at operation 410, when the positive professional transition evaluator 220 of FIG. 2 accesses the new company string and the new title string, at operation 410. At operation 420, the positive professional transition evaluator 220 determines whether the profile update indicates that the member is no longer employed. In one embodiment, this determination may be made based on examining the new company string and the new title string with respect to a dictionary of terms that have been identified as indicative of lack of employment or lack of paid employment. If the positive professional transition evaluator 220 determines that the profile update indicates that the member is no longer employed, the positive professional transition evaluator 220 identifies the update to profile data as not indicative of a positive professional transition (operation 430). Otherwise, the positive professional transition evaluator 220 accesses the previous company string and the new company string, at operation 440.

As explained above, in one embodiment, a profile update evaluator identifies a change to profile data as indicative of a positive professional transition when the new company name string and the previous company name string have been determined to represent different companies where, the change to the current company name suggests that the member transitioned from one company to another. At operation 450, the professional transition evaluator 220 commences a company similarity phase to determine whether the new company name string and the previous company name string have been determined to represent different companies. The company similarity phase, in one example embodiment is based on a modified term frequency-inverse document frequency (tf-IDF) approach, as described above. If it is determined, at operation 450, that the new company name string and the previous company name represent different companies, the positive professional transition evaluator 220 identifies the update to profile data as indicative of a positive professional transition (operation 460).

Another scenario where a profile update evaluator identifies a change to profile data as indicative of a positive professional transition is when the pair comprising a new title string and a previous title string indicates a professional promotion of the associated member. At operation 470, the positive professional transition evaluator 220 accesses the previous title string and the new title string, and performs title standardization with respect to these strings at operation 480. One example methodology for deriving respective standardized titles for the new title string and the previous title string is described above. At operation 490, the positive professional transition evaluator 220 examines these standardized title strings to determine whether the transition represented by the new title string and the previous title string suggests a professional advancement or a promotion. As stated above, the transition represented by the new title string and the previous title string may be identified as indicative of a professional advancement or a promotion if the previous title string and the new title string are sufficiently different or dissimilar.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

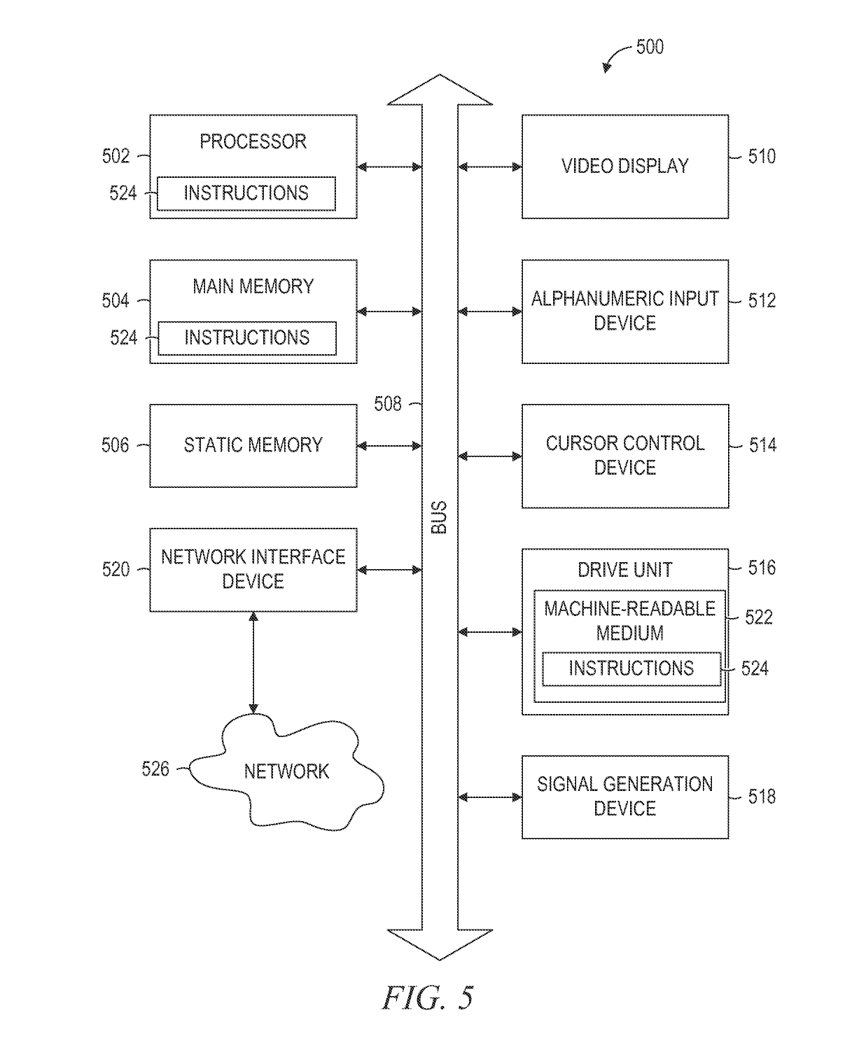

FIG. 5 is a diagrammatic representation of a machine in the example form of a computer system 500 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 505. The computer system 500 may further include a video display unit 510 (e.g., a liquid crystal display (LCD) or a cathode ray tube (CRT)). The computer system 500 also includes an alpha-numeric input device 512 (e.g., a keyboard), a user interface (UI) navigation device 514 (e.g., a cursor control device), a disk drive unit 516, a signal generation device 518 (e.g., a speaker) and a network interface device 520.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, with the main memory 504 and the processor 502 also constituting machine-readable media.

The software 524 may further be transmitted or received over a network 526 via the network interface device 520 utilizing any one of a number of well-known transfer protocols (e.g., Hyper Text Transfer Protocol (HTTP)).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a method and system to evaluate an update to a profile representing a member in an on-line social network system has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
detecting a change to profile data in a member profile, the member profile representing a member in an on-line social network;
determining, using at least one processor, that the change to profile data is indicative of a positive professional transition; and
causing an announcement related to the change to the profile data to be presented on a display device.

2. The method of claim 1, wherein the change to profile data is associated with a new company name string and a previous company name string, the determining that the change to profile data is indicative of a positive professional transition comprises determining that a current company represented by the new company name string is distinct from a previous company represented by the previous company name string.

3. The method of claim 2, wherein the new company name string and the previous company name string are provided in separate job position entries in the member profile.

4. The method of claim 2, wherein the new company name string replaced the previous company name in a job position entry in the member profile.

5. The method of claim 2, wherein the determining that the new company name string is distinct from the previous company comprises utilizing a combination of edit distance scoring and a term frequency inverse document frequency approach.

6. The method of claim 1, wherein the determining that the change to profile data is indicative of a positive professional transition comprises determining that the change to profile data is indicative of a continued employment.

7. The method of claim 6, wherein the determining that the change to profile data is indicative of a continued employment comprises utilizing a list of terms indicative of lack of employment.

8. The method of claim 1, wherein the change to profile data is associated with a new title string and a previous title string, the determining that the change to profile data is indicative of a positive professional transition comprises detecting one or more seniority modifier words in one or both of the new title string and the previous title string.

9. The method of claim 1, wherein the announcement related to the change to the profile data is included on a news feed page of a further member of the on-line social network.

10. The method of claim 1, wherein the causing of the announcement related to the change to the profile data to be presented on a display device includes causing a presentation of a visual control selectable to trigger a communication to be sent to the member.

11. A computer-implemented system comprising:
a profile change detector, implemented using at least one processor, to detect a change to profile data in a member profile, the member profile representing a member in an on-line social network;
a positive professional transition evaluator, implemented using at least one processor, to determine that the change to profile data is indicative of a positive professional transition; and
a presentation module, implemented using at least one processor, to cause an announcement related to the change to the profile data to be presented on a display device.

12. The system of claim 11, wherein the change to profile data is associated with a new company name string and a previous company name string, the positive professional transition evaluator being to determine that a current company represented by the new company name string is distinct from a previous company represented by the previous company name string.

13. The system of claim 12, wherein the new company name string and the previous company name string are provided in separate job position entries in the member profile.

14. The system of claim 12, wherein the new company name string replaced the previous company name in a job position entry in the member profile.

15. The system of claim 12, wherein the positive professional transition evaluator utilizes a combination of edit distance scoring and a term frequency inverse document frequency approach to determine that a current company represented by the new company name string is distinct from a previous company represented by the previous company name string.

16. The system of claim 11, wherein the positive professional transition evaluator is to determine that the change to profile data is indicative of a continued employment.

17. The system of claim 16, wherein the positive professional transition evaluator is to utilize a list of terms indicative of lack of employment.

18. The system of claim 11, wherein the positive professional transition evaluator is to detect one or more seniority modifier words in one or both of the new title string and the previous title string.

19. The system of claim 11, wherein the announcement related to the change to the profile data is included on a news feed page of a further member of the on-line social network.

20. A machine-readable non-transitory storage medium having instruction data executable by a machine to cause the machine to perform operations comprising:
detecting a change to profile data in a member profile, the member profile representing a member in an on-line social network;
determining that the change to profile data is indicative of a positive professional transition; and
causing an invitation to congratulate the member to be presented on a display device.
